(19) United States
(12) Patent Application Publication
(10) Pub. No.: US 2025/0003442 A1
(43) Pub. Date: Jan. 2, 2025

(54) Clip-On U-Nut

(71) Applicant: Illinois Tool Works Inc., Glenview, IL (US)

(72) Inventors: Johnson ALLANDE, Maharashtra (IN); Mahantesh GOKAVI, Maharashtra (IN); Satish JADHAV, Maharashtra (IN)

(21) Appl. No.: 18/755,166

(22) Filed: Jun. 26, 2024

(30) Foreign Application Priority Data
Jun. 30, 2023 (IN) 202311044153

(51) Int. Cl. F16B 37/04

(52) U.S. Cl. CPC F16B 37/041

(57) ABSTRACT

Examples of the present subject matter disclose clip-on u-nut (100) having a first leg (102) having a first aperture (106), and a second leg (104) adjoined to the first leg (102) via a u-bend (108). This connection establishes a gap (116) varying between the first leg (102) and the second leg (104), which are relatively moveable to accommodate a part (200) in the gap therebetween. The second leg (104) has a misalignment adjustment component (112) that comprises a body (120) and a second aperture (122) that is an oblong-shaped through-hole. The second aperture (122) co-operates with the first aperture (106) to receive a fastener (202). The first aperture (106) and the second aperture (122) have a plurality of relative fastening positions with respect to each other to accommodate the fastener (202) in multiple orientations, allowing the clip-on u-nut (100) to accommodate variations in part sizes and thicknesses.

### RELATED APPLICATION

The present application claims the benefit of Indian Patent Application Nos. 202311044153, filed Jun. 30, 2023, each titled “Clip-On U-Nut,” the contents of which is hereby incorporated by reference.

### BACKGROUND

Conventionally, a clip-on u-nut is used for fastening together components, such as panels, sheet metals, and the like. Generally, the clip-on u-nut has two joined legs, namely a first leg and a second leg joined by the u-shaped bend. The first leg and the second leg are spaced apart, for instance, by the width of the u-shaped bend, to accommodate a component therebetween. The first leg and the second leg, each have an aperture, such that the apertures on the two legs are aligned to a certain extent and the two components to be connected are fastened using a fastener having external threads, such as a bolt or a screw, that is disposed in the apertures of the first leg to the second leg to fasten the two components.

### SUMMARY

The present disclosure relates generally to a clip-on u-nut, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A illustrates an isometric view of a clip-on u-nut, according to an example of the present subject matter.

FIG. 1B illustrates a side view of the clip-on u-nut, according to an example of the present subject matter.

FIG. 1C illustrates a front-side view of the clip-on u-nut, according to an example of the present subject matter.

FIG. 1D illustrates a rear-side view of the clip-on u-nut, according to an example of the present subject matter.

FIG. 1E illustrates a top view of the clip-on u-nut, according to an example of the present subject matter.

FIG. 1F illustrates a top view of the clip-on u-nut, according to another example of the present subject matter.

FIG. 2A illustrates a side view of the clip-on u-nut accommodating a part, according to an example of the present subject matter.

FIG. 2B illustrates a side view of a fastener fastening the part to the clip-on u-nut, according to an example of the present subject matter.

FIG. 2C illustrates a sectional-side view of the clip-on u-nut showcasing relative motion between a first leg and a second leg after accommodating the part, according to an example of the present subject matter.

FIG. 2D illustrates a sectional-side view of the fastener fastening the part also showcasing relative motion between a first leg and a second leg after accommodating the part, according to an example of the present subject matter.

FIG. 3 illustrates a fastening assembly comprising the clip-on u-nut, according to an example of the present subject matter.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Conventionally, a clip-on u-nut is used for fastening together components in various applications, for example, in the automobile industry. For instance, the clip-on u-nut is used to fasten components to an instrument panel, a door, and the like. The component may be a sheet metal panel or a plastic panel. Generally, the clip-on u-nut is made of a metal and has two joined legs, namely a first leg and a second leg joined by a u-shaped bend. The first leg and the second leg are spaced apart, for instance, by the width of the u-shaped bend, to accommodate the component and each of the legs has an aperture to allow the clip-on u-nut to function as a nut for assembling components thereto. Accordingly, another component to be coupled to the first abuts against one of the legs, and the two components are joined together using a fastener passing through the two components and the clip-on u-nut.

The first component and the second component each have holes that are to be positioned corresponding to the apertures on the respective leg of the clip-on u-nut. In assembly, the clip-on u-nut is mounted to one component in a manner a clip is mounted, i.e., with the component positioned between the two legs, to align the hole on that component with the aperture in one of the legs of the clip-on u-nut. The assembly of the first component with the clip-on u-nut, which is an interim step in the complete assembly, is referred to as an intermediate assembly. Then the second component is positioned with respect to the intermediate assembly to couple the two components. In other words, the other component is positioned on the other side of either of the two legs to align the hole on that component with the aperture on the abutting leg. During assembly of the clip-on u-nut with the two components, the apertures in the two legs of the clip-on u-nut can be forced to be aligned with each other by fastening the two legs, as well as the two components, using a threaded fastener.

As mentioned above, the conventional clip-on u-nut is fabricated using a metallic material and may be unyielding and difficult to work with, for instance, during assembly and while fastening the components. For example, in certain cases, the thickness of either the first component that is to be accommodated in the space between the first leg and the second leg is significantly greater than the size of the u-shaped bend. As a result, positioning the component between the two legs of the clip-on u-nut may cause misalignment of the apertures on the two legs. In other words, as the distance between the first leg and the second leg increases because of the thickness of the component accommodated therebetween i.e., between the first leg and the second leg, the misalignment between the apertures on the two legs also increases. As a result, fastening the components using the conventional clip-on u-nut through the threaded fastener may require considerable force to align the apertures. Additionally, fastening may also be time-consuming, potentially hampering productivity during the assembly process. For instance, an operator may be required to apply a considerable amount of force to fasten the threaded fastener through the two apertures of the legs of the clip-on u-nut that are distanced. Additionally, the conventional clip-on u-nut has to be fabricated with a metallic material that can withstand such force and is not damaged in the process of assembly; otherwise, the service life of the clip-on u-nut, the components, and/or the fastener may be adversely affected. For instance, the threaded fastener may have to be replaced at frequent intervals, leading to the high maintenance cost of repair. Therefore, such clip-on u-nuts may not only be costly, owing to the metallic material, but they may also be heavy for transportation in bulk. In addition to the above, the conventional clip-on u-nut fabricated with metal is manufactured through casting, post-heat treatment, and metal working. The process of manufacturing such conventional clip-on u-nuts and the materials involved may also be costly.

The present subject matter discloses examples and aspects to inter alia address the above-mentioned problems. The present subject matter, in one example, relates to a clip-on u-nut which is fabricated with plastic material and is designed to be durable, effective, and less costly while having the flexibility to accommodate a range of components with varying thicknesses. The clip-on u-nut of the present subject matter may be used for fastening a plurality of components, such as sheet metal panels, plastic panels, and the like. The components that can be fastened using the clip-on u-nut are hereinafter referred to collectively as parts and individually as a part.

The clip-on u-nut of the present subject matter may include a first leg and a second leg. The first leg may have a first aperture. The first aperture may be an opening on the first leg and may be of a shape on the first leg corresponding to a shape of a fastener that it can receive to fasten the part. The second leg may have a misalignment adjustment component that may be used for providing effective space to adjust the position of the fastener that may be received to effectively fasten without applying any additional force on the fastener even when there is a misalignment between the first aperture and the misalignment adjustment component or the alignment between the first aperture and the misalignment adjustment component is at a certain angle from one another. The misalignment adjustment component is designed in a manner to provide sufficient area for adjusting the fastener for fastening. The misalignment adjustment component may have a body and a second aperture. The second aperture may be formed as an oblong-shaped through-hole in the body of the misalignment adjustment component. The oblong-shaped through-hole due to its oblong shape provides sufficient space for adjustment of the fastener and for efficiently fastening even when there is misalignment between the first aperture and the second aperture caused by varying thickness of the part accommodated between the first leg and the second leg, as will be explained. In other words, even when the first aperture and the second aperture are not aligned or are at an angle from one another, the oblong-shape of the oblong-shaped through-hole of the misalignment adjustment component provides sufficient space for adjustment of the fastener to effectively fasten. Since, the misalignment adjustment component through the oblong-shaped through-hole provides sufficient space for adjustment, the fastener that may be used for fastening may not be required to fasten by applying additional force, as the fastener may be adjusted to fasten even when the first aperture and the second aperture may be misaligned. In this regard, neither the fastener nor the clip-on u-nut of the present subject matter may be damaged in the process of the assembly, and the service life of the fastener and the clip-on u-nut may also not be adversely affected during assembly.

The second leg may be connected to the first leg through a u-bend to create a gap with the first leg. The first leg and the second leg may be contiguous with each other through the u-bend to create the gap therebetween, where the gap may be the distance between the first leg and the second. The u-bend may be a u-shaped bend in the clip-on u-nut connecting the first leg and the second leg. In other words, the second leg and the first leg of the clip-on u-nut of the present subject matter are joined through the u-bend from the first leg towards the second leg, which may form a U-shape with space in between the second leg and the first leg.

The first leg and the second leg connected through the u-bend may extend away from the u-bend towards a free end of the clip-on u-nut. Accordingly, the first leg and the second leg may each have the free end in proximity to each other. The free end may be an end that may be free and may not be coupled to or connected with.

The first leg and the second leg may be connected in a manner that the first leg and the second leg may be relatively moveable with respect to each other about the u-bend to vary the gap therebetween. The gap between the first leg and the second leg, by u-bend, may vary to accommodate the part therebetween. The part that may be accommodated between the first leg and the second leg, may have varying thicknesses. The varying thickness implies that the part that may be accommodated between the first leg and the second leg and that may be fastened through the clip-on u-nut of the present subject matter may be of any thickness, and the part is not limited to have any set thickness. In this example, the part of any thickness may be accommodated between the first leg and the second leg. The part when accommodated therebetween, i.e., between the first leg and the second leg may cause the first leg and the second leg to move relatively with respect to each other, thereby causing the gap between the first leg and the second leg to vary. In this example, since the first leg and the second leg are connected through the u-bend to create the gap, the first leg and the second leg may be relatively moveable through the respective free ends and about the u-bend to vary the gap therebetween i.e., between the first leg and the second leg. The gap between the first leg and the second leg may vary because of the varying thickness of the part.

In order to effectively fasten the part that may be of any thickness accommodated between the first leg and the second leg to another component, for example, the instrument panel or the door of the vehicle, the first aperture and the second aperture may co-operate with one another to accommodate a fastener. In an example, the fastener may be any of a bolt, a screw, and the like. To fasten, the second aperture may be capable of accommodating the fastener in co-operation with the first aperture. As stated above, the misalignment adjustment component through the oblong-shaped through-hole may provide sufficient space for adjustment of the fastener that may be used for fastening without applying additional force, as the fastener may be adjusted to fasten even when the first aperture and the second aperture may be misaligned are at an angle from one another, the oblong-shape of the oblong-shaped through-hole of the second aperture of the misalignment adjustment component may provide sufficient space for adjustment of the fastener to effectively fasten. In this regard, the second aperture and the first aperture may in co-operation with one another, allow the second aperture to receive the fastener to fasten the part to another component, for example, the instrument panel or the door of the vehicle.

Coming back to the design of the apertures, the first aperture and the second aperture may have a plurality of relative fastening positions with respect to each other to accommodate the fastener in co-operation with each other. In each of the plurality of relative fastening positions, the first aperture and the second aperture may accommodate the fastener therein. In this example, as the first leg and the second leg may move relatively with respect to each other when the part is accommodated therebetween, correspondingly, the first aperture and the second aperture may be caused to move as well, thereby causing a change in alignment of axes of the first aperture and the second aperture with respect to each other. The oblong-shaped through-hole of the second aperture may in co-operation with the first aperture at any of the plurality of relative fastening positions be operable to accommodate the fastener therein.

In view of the above, the clip-on u-nut of the present subject matter may be designed as such to be durable, effective, and less costly. The clip-on u-nut of the present subject matter through the misalignment adjustment component provides flexibility to fasten components of varying thicknesses. Additionally, the clip-on u-nut of the present subject matter is fabricated with plastic material, and therefore the clip-on u-nut may be manufactured through a molding process, which is less time-consuming and less expensive. The misalignment adjustment component of the clip-on u-nut of the present subject matter may be designed to effectively fasten by receiving and adjusting the fastener even in case of misalignment between the first aperture and the second aperture. The oblong-shaped through-hole of the second aperture of the misalignment adjustment component allows to receive the fastener at relative fastening positions and fasten without applying any additional force even when there is a misalignment or the alignment between the first aperture and the misalignment adjustment component is at a certain angle from one another. The misalignment adjustment component is designed in a manner to provide sufficient area for adjusting the fastener at relative fastening positions to effectively fasten. The oblong-shaped through-hole due to its oblong shape provides sufficient space for adjustment of the fastener and for efficiently fastening at relative fastening positions even when there is misalignment caused by varying gaps between the first aperture and the second aperture caused by varying thickness of the part accommodated therebetween. As a result, any part with any thickness may be accommodated by the clip-on u-nut of the present subject matter, and the misalignment adjustment component may allow receiving the fastener to effectively fasten at relative fastening positions, even when the first aperture and the second aperture are not aligned or are at an angle from one another. Since, the misalignment adjustment component through the oblong-shaped through-hole provides sufficient space for adjustment, the fastener that may be used for fastening may not be required to fasten by applying additional force, as the fastener may be adjusted to fasten even when the first aperture and the second aperture may be misaligned. In this regard, neither the fastener nor the clip-on u-nut of the present subject matter may be damaged in the process of the assembly, and also the service life of the fastener and the clip-on u-nut may also not be adversely affected during assembly. The clip-on u-nut of the present subject matter may be fabricated with plastic material and therefore, may be designed to be durable, effective, and less costly while having the flexibility to accommodate a range of components with varying thicknesses and since the clip-on u-nut of the present subject matter may be manufactured by molding process, the process of manufacturing may also be cost-effective.

The present subject matter is further described with reference to the accompanying figures. Wherever possible, the same reference numerals are used in the figures and the following description to refer to the same or similar parts. It should be noted that the description and figures merely illustrate the principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

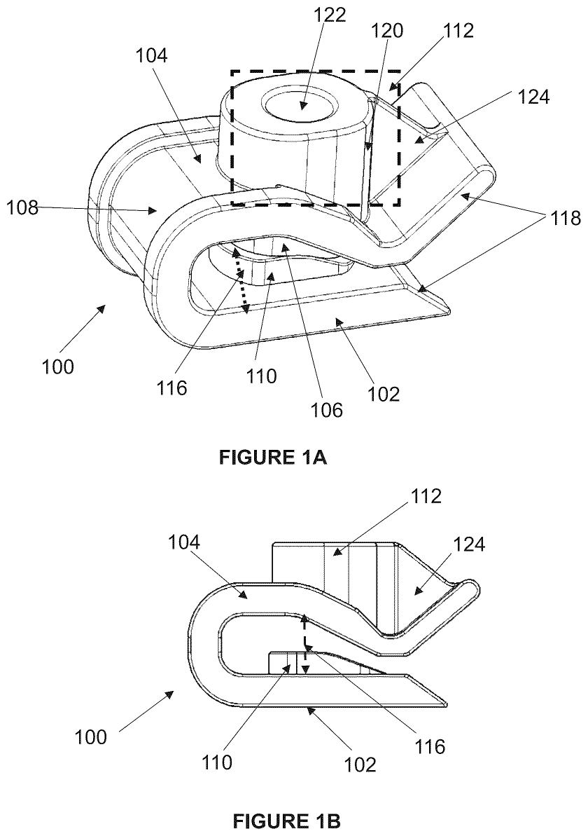

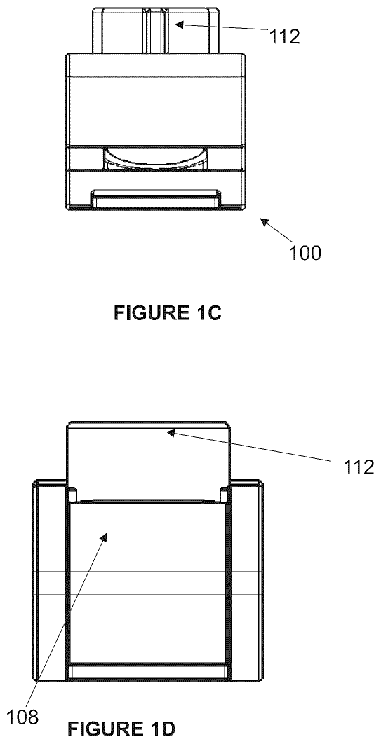

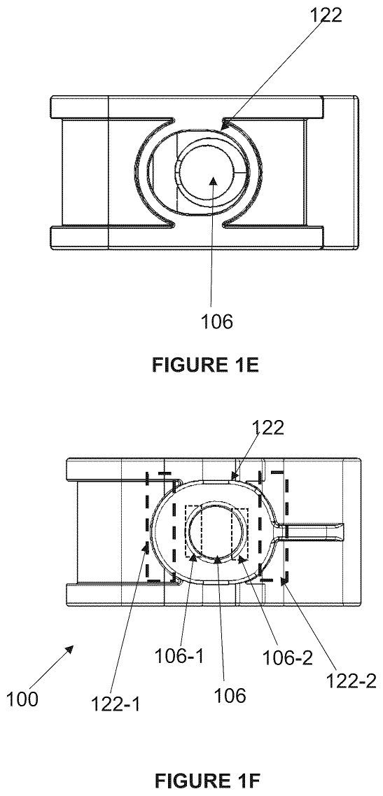

FIG. 1A illustrates an isometric view of a clip-on u-nut 100, according to an example of the present subject matter. FIG. 1B illustrates a side view of the clip-on u-nut 100, according to an example of the present subject matter. FIG. 1C illustrates a front-side view of the clip-on u-nut 100, according to an example of the present subject matter. FIG. 1D illustrates a rear-side view of the clip-on u-nut 100, according to an example of the present subject matter. FIG. 1E illustrates a top view of the clip-on u-nut 100, according to an example of the present subject matter. FIG. 1F illustrates a top view of the clip-on u-nut 100, according to another example of the present subject matter. For the sake of brevity, FIGS. 1A-IF have been explained in conjunction with each other.

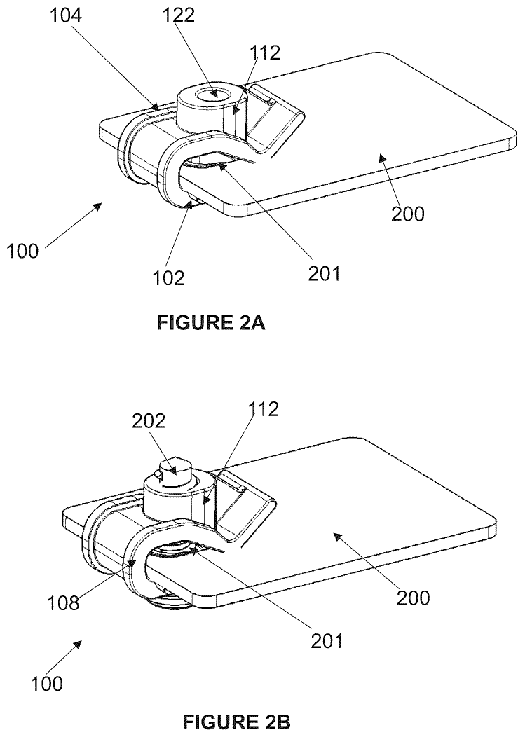

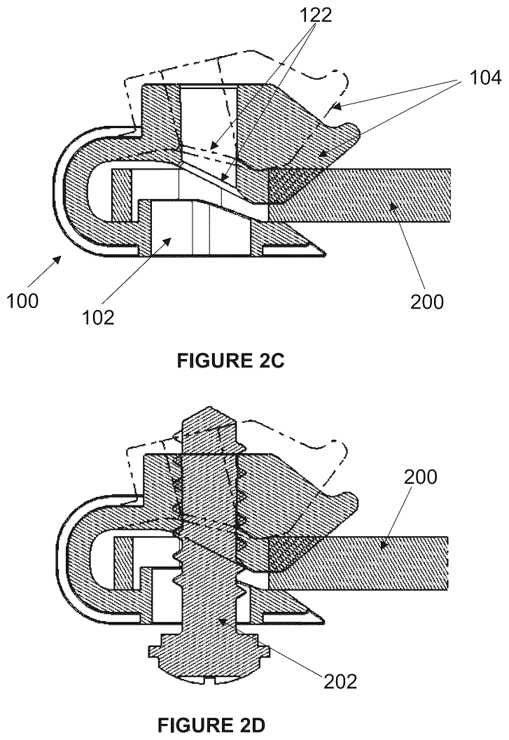

The clip-on u-nut 100 may be fabricated with plastic material and may be designed as such to be durable, effective, and less costly while having the flexibility to accommodate a range of components with varying thicknesses. The clip-on u-nut 100 of the present subject matter may be accommodated to fasten a plurality of components (not shown), such as panels, sheet metals, and the like. Each of the plurality of components has been interchangeably referred to hereinbelow as parts and individually referred to as part (shown in FIGS. 2A-2D as 200).

The clip-on u-nut 100 of the present subject matter may include a first leg 102, a second leg 104, and a u-bend 108. The first leg 102 may have a first aperture 106 and a locator 110. The second leg 104 may have a misalignment adjustment component 112.

The first leg 102 and the second leg 104 may be in connection with one another through the u-bend 108. The u-bend 108 may be a u-shaped bend in the clip-on u-nut 100 connecting the first leg 102 and the second leg 104. The u-bend 108 may have two ends (not shown), and one of the two ends may be integral with the first leg 102 and another one of the two ends may be integral with the second leg 104. The first leg 102, the second leg 104, and the u-bend 108 may be integral to one another. In an example, the second leg 104 may be vertically above the first leg 102, and the u-bend 108 may be connected with the first leg 102 and the second leg 104 through one of the ends (not shown) of the first leg 102 and the second leg 104, where one of the ends (not shown) of the first leg 102 and corresponding one of the ends (not shown) of the second leg 104 that may be connected to corresponding one of two ends the u-bend 108 may be in proximity to one another and may be directed to face in the same direction. In another example, the first leg 102 may be vertically above the second leg 104, and the u-bend 108 may connect the first leg 102 and the second leg 104.

The first leg 102 and the second leg 104 connected through u-bend 108 may extend away from the u-bend 108 towards a free end 118 of the clip-on u-nut 100. In this example, the first leg 102 and the second leg 104 may each have the other of the ends opposite to the one of the ends connected to the u-bend 108, which may be free and not coupled or connected with, the other of ends of the first leg 102 and the second leg 104 are collectively referred to as the free end(s) 118. The free end 118 may be an end of the clip-on u-nut 100, where the first leg 102 and the second leg 104 may have the respective other ends, that are opposite to the ends connected to the u-bend 108, to be free.

The second leg 104 may be connected to the first leg 102 through the u-bend 108 to create a gap 116 with the first leg 102. The first leg 102 and the second leg 104 may be contiguous with each other through the u-bend 108 to create the gap 116 therebetween, where the gap 116 may be the distance between the first leg 102 and the second leg 104. The part that may be required to be fastened with another component, for example, an instrument panel, a component of a vehicle, and the like, through the clip-on u-nut 100 may be accommodated between the first leg 102 and the second leg 104. The part (not shown) that may be accommodated between the first leg 102 and the second leg 104, may be of any varying thicknesses. The varying thickness implies that the part that may be accommodated between the first leg 102 and the second leg 104 and that may be fastened through the clip-on u-nut 100 of the present subject matter may be of any thickness, and the part is not limited to having any set thickness. The part with any variation of thickness can be accommodated between the first leg 102 and the second leg 104, for it to be fastened to another component through the clip-on u-nut 100. The part when accommodated therebetween, i.e., between the first leg 102 and the second leg 104 may cause the first leg 102 and the second leg 104 to move relatively with respect to each other, thereby causing the gap 116 between the first leg 102 and the second leg 104 to vary. In this example, since the first leg 102 and the second leg 104 are connected through the u-bend 108 to create the gap 116, the first leg 102 and the second leg 104 may be relatively moveable through the free ends of the respective legs i.e., the first leg 102 and the second leg 104. Additionally, the relative motion between the first leg 102 and the second leg 104 that may be caused may be about the u-bend 108 to vary the gap 116 therebetween. The gap 116 between the first leg 102 and the second leg 104 may vary because of the varying thickness of the part. This will be explained later.

The first aperture 106 may be an opening on the first leg 102, where the first aperture 106 may be of a shape on the first leg 102 corresponding to a shape of a fastener (shown in FIG. 2B as 202) to fasten the part (shown in FIG. 2A-2D as 200). In an example, the fastener may be any fastening component, for example, a bolt, a screw, and the like, and may be of any size. The shape and size of the first aperture 106 and fastener that may be employed for fastening may correspond with one another. The first aperture 106 has a u-bend side of rim 106-1 and a free end side of rim 106-2. The u-bend side of rim 106-1 of the first aperture 106 on the first leg 102 may be in proximity to the u-bend 108 and the free end side of rim 106-2 of the first aperture 106 on the first leg 102 may be in proximity to the free end 118.

In one example, the first leg 102 may have an inner surface and an outer surface, where the inner surface of the first leg 102 may be facing towards the second leg 104 and the outer surface of the first leg 102 may be facing away from the second leg 104. The first leg 102 may have the locator 110 extending from the first leg 102 towards the second leg 104 along an axial direction of the first aperture 106. In one example, the first leg 102 may have the locator 110 extending from the inner surface of the first leg 102 towards the second leg 104 along an axial direction of the first aperture 106. The locator 110 may be connected to the first aperture and may be positioned in the space between the second leg 104 and the first leg 102. In another example, the first leg 102 may have the locator 110 extending from the inner surface of the first leg 102 towards the second leg 104 along an axial direction of the first aperture 106 and another of the locator 110 extending from the outer surface of the first leg 102 away from the second leg 104 along the axial direct of the first aperture 106 away from the second leg 104. The locator 110 may be fabricated with plastic material. In an example, the locator 110 may be an extension of the axial direction of the first aperture 106, with the same radial dimensions as the first aperture 106. The part (not shown) that may be accommodated between the first leg 102 and the second leg 104, may be accommodated on the locator 110. The locator 110 may lock the components during the fastening operation, as will be explained later. In other words, the locator 110 may locate the part 200 with respect to the first leg 102 in a fastening position between the first leg 102 and the second leg 104. The fastening position may be the position at which the locator may accommodate the part and hold on to it, and restrict any inadvertent movement, such that, for instance, with respect to the illustrated example, the part may be aligned with the first aperture 106 through the locator 110 making part to be easily accommodated and held on to by the locator 110 in the fastening position. In this fastening position, since the part is held by the locator 110, the part may be easily fastened by passing the fastener through the first aperture 106.

The misalignment adjustment component 112 may have a body 120 and a second aperture 122. In this case, the second leg 104 may have the second aperture 122. The body 120 of the misalignment adjustment component 112 may extend along an axial direction of the second aperture 122. In other words, the second aperture 122 may extend along its length to form the body 120. In this example, the body 120 may be an extension extending away from the second leg 104 along the axial direction of the second aperture 122. The second aperture 122 may be formed of an oblong-shaped through-hole in the body 120 of the misalignment adjustment component 112.

In addition, the body 120 of the misalignment adjustment component 112 may be connected to the second leg 104 through a connecting support 124. The connecting support 124 may provide support to the misalignment adjustment component 112, such that the misalignment adjustment component 112 does not deflect while fastening. The connecting support 124 may be provided between the body 120 and a point on the second leg in proximity to the free end 118. In this manner, the misalignment adjustment component 112 may be like an extension over the second leg 104, may be provided with support, and may not deflect from its position when the fastener may be adjusted about the misalignment adjustment component, and may effectively fasten the part.

The second aperture 122 may have a first edge 122-1 and a second edge 122-2, where the first edge 122-1 of the second aperture 122 on the second leg 104 may be in proximity to the u-bend 108 and the second edge of the second aperture 122 on the second leg 104 may be in proximity to the free end.

The second aperture 122 formed as the oblong-shaped through-hole is designed in a manner to have a first elongated length and a second elongated length. The first elongated length may be measured along a longitudinal axis along the length of the second aperture 122 in the direction of the oblong shape i.e., the length between the first edge 122-1 and the second edge 122-2. The second elongated length may be defined by a lateral axis perpendicular to the longitudinal axis and may be measured perpendicular to a direction of measurement of the first elongated length and may be a measure of a width of the second aperture 122. In one example, the width of the second elongated length of the second aperture of the misalignment adjustment component 112 may be substantially equal to a diameter of the first aperture 106 and the first elongated length may be substantially greater than the width of the second aperture 122 and the diameter of the first aperture 106. The length of the second aperture 122 may be greater than the width of the second aperture 122. In an example, the width of the second aperture 122 of the misalignment adjustment component 112 may be substantially equal to the diameter of the first aperture 106. Correspondingly, the first elongated length i.e., the length between the first edge 122-1 and the second edge 122-2 may be greater than the diameter of the first aperture 106.

In one example, a central longitudinal axis of the first aperture 106 extending in an axial direction therefrom and a central longitudinal axis of the second aperture 122 extending in an axial direction therefrom may be aligned to a certain extent with one another. In another example, the central longitudinal axis of the first aperture 106 and the central longitudinal axis of the second aperture 122 may be at an angle with respect to each other.

The first aperture 106 and the second aperture 122 may co-operate with one another to accommodate the fastener to fasten the part. In an example, the first aperture 106 and the second aperture 122 may have a plurality of internal threads (not shown). In an example, the fastener may be any of a bolt, a screw, and the like. To fasten, the second aperture 122 may be capable of accommodating the fastener in co-operation with the first aperture 106. The second aperture 122 and the first aperture 106 may in co-operation with one another, allow the second aperture 122 to receive the fastener to fasten the part to another component, for example, the instrument panel or the door of the vehicle.

The first aperture 106 and the second aperture 122 may have a plurality of relative fastening positions with respect to each other to accommodate the fastener in co-operation with each other. In each of the plurality of relative fastening positions, the first aperture 106 and the second aperture 122 may accommodate the fastener therein, as will be explained.

In one example, the clip-on u-nut is manufactured by a molding process. In an example, the clip-on u-nut 100 may be fabricated with plastic material. The fabrication with plastic material may provide the clip-on u-nut 100 the flexibility to move and be adjusted, as required.

FIG. 2A illustrates a side view of the clip-on u-nut 100 accommodating a part 200, according to an example of the present subject matter. FIG. 2B illustrates a side view of a fastener 202 fastening the part 200 to the clip-on u-nut 100, according to an example of the present subject matter. FIG. 2C illustrates a sectional side view of the clip-on u-nut 100 showcasing relative motion between the first leg 102 and the second leg 104 after accommodating the part 200, according to an example of the present subject matter. FIG. 2D illustrates a sectional-side view of the fastener 202 fastening the part also showcasing relative motion between the first leg 102 and the second leg 104 after accommodating the part 200, according to an example of the present subject matter. For the sake of brevity, FIGS. 2A-2D have been explained in conjunction with each other.

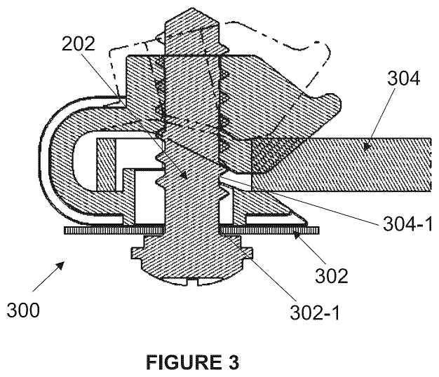

In an implementation, the clip-on u-nut 100 may be assembled onto a panel (not shown) and may be used to fasten the parts 200 to other parts (as will be explained with respect to FIG. 3). In an example, the other parts (not shown) may for example be the instrument panel, a metal sheet, or any component of the vehicle.

The implementations hereinafter have been explained in reference to clip-on u-nut 100 accommodating the part 200. Additionally, illustrations hereinbelow have been illustrated with respect to the part 200 which may be a single component, however, a plurality of parts may be fastened, as will be explained.

During fastening the part 200 using the clip-on u-nut 100 of the present subject matter, the part 200 may be assembled in the space between the second leg 104 and the first leg 102, such that the part 200 may be assembled to form the gap 116 between the first leg 102 and the second leg 104, where the gap 116 may be vary based on the thickness of the part (that may vary as well).

In one example, the gap 116 between the first leg 102 and the second leg 104 may already exist because of the u-bend 108, even if the part 200 is not accommodated therebetween. In another example, the gap 116 between the first leg 102 and the second leg 104 may exist after the part 200 is accommodated therebetween.

The gap 116 i.e., the distance between the first leg 102 and the second leg 104 may vary to accommodate the part 200 therebetween. The part 200 that may be accommodated between the first leg 102 and the second leg 104, may have varying thicknesses. The varying thickness implies that the part 200 that may be accommodated between the first leg 102 and the second leg 104 and that may be fastened through the clip-on u-nut 100 of the present subject matter may be of any thickness, and the part 200 is not limited to have any set thickness. The part 200 when accommodated therebetween, i.e., between the first leg 102 and the second leg 104 may cause the first leg 102 and the second leg 104 to move relatively with respect to each other, thereby causing the gap 116 between the first leg 102 and the second leg 104 to vary. In one instance, since the first leg 102 and the second leg 104 are connected through the u-bend 108 to create the gap 116, i.e., as soon as the part 200 is accommodated therebetween on the locator 110 the first leg 102 and the second leg 104 may be caused to be relatively moveable through the respective free ends 118 and about the u-bend 108. The locator 110 may be to locate the part 200 with respect to the first leg 102 in a fastening position between the first leg 102 and the second leg 104. In another instance, since the first leg 102 and the second leg 104 are connected through the u-bend 108 to create the gap 116, as stated above, the gap 116 may already exist therebetween in an original state, and as soon as the part 200 is accommodated therebetween on the locator 110 the first leg 102 and the second leg 104 may be caused to be relatively moveable through the respective free ends 118 and about the u-bend 108 causing variation in the gap 116 therebetween. The original state is when no external force is applied and the first leg 102 and the second leg 104 of the clip-on u-nut 100 are in their respective home positions. The relative motion to accommodate the part 200 of any thickness may vary the gap 116 therebetween. The gap 116 between the first leg 102 and the second leg 104 may vary because of the varying thickness of the part 200.

In the above examples, as the first leg 102 and the second leg 104 may move relatively with respect to each other when the part 200 is accommodated therebetween, correspondingly, the first aperture 106 and the second aperture 122 may be caused to move as well, thereby causing a change in alignment of central longitudinal axes of the first aperture 106 and the second aperture 122 with respect to each other. The oblong-shaped through-hole of the second aperture 122 may in co-operation with the first aperture 106 at any of the plurality of relative fastening positions be operable to accommodate the fastener therein by allowing adjustment of the fastener.

The first aperture 106 and the second aperture 122, while being relatively moveable because of the relative motion between the first leg 102 and the second leg 104 while accommodating the part that causes a variation in the gap 116, may co-operate with one another at the plurality of relative fastening positions with respect to each other. In each of the plurality of relative fastening positions, the first aperture 106 and the second aperture 122 may accommodate the fastener 202 therein, depending upon the gap therebetween. The relative fastening positions may be the range of positions of co-operation between the first aperture 106 and the second aperture 122 at and between the maximum gap and the minimum gap to receive and accommodate the fastener. In other words, the first aperture 106 and the second aperture 122 may cooperate within the relative fastening positions that may be a range of positions of co-operation between the first aperture 106 and the second aperture 122 at varying gaps caused by the part accommodated between the first leg 102 and the second leg 104 to accommodate the fastener. The varying gap may be in the range of and from the minimum gap to and at the maximum gap.

The minimum gap may be the gap that may be in the lowest range of varying gaps between the first leg 102 and the second leg 104. At the minimum gap 116 between the first leg 102 and the second leg 104, the first aperture 106 and the second aperture 122 may co-operate with one another, in a manner that the central longitudinal axes may be positioned at an angle with respect to each other and the part 200 may be accommodated therebetween.

In one example, the first aperture 106 and the second aperture 122 may be in the original state aligned with each other, i.e., when no part is accommodated therebetween. In this example, in an instance, the part 200 may have less thickness than the gap 116. The part 200 when accommodated may not cause any change in the gap between the first leg 102 and the second leg 104, and may not cause any relative motion between the first leg 102 and the second leg 104. In another instance, in this one example, the part 200 may have thickness that may vary the gap 116 between the first leg 102 and the second leg 104, thereby causing the first leg 102 and the second leg 104 to relatively move to accommodate the part 200 therebetween. In this instance, the first aperture 106 and the second aperture 122 may be caused to be misaligned or aligned at an angle with respect to each other. The minimum gap for co-operation between the first aperture 106 and the second aperture 122, in this one example, may be the gap 116 when the clip-on u-nut is in its original state, i.e., when no part 200 is accommodated therebetween, or as stated above, the part 200 accommodated therebetween has such thickness to be less than the gap 116 in the original state.

In another example, the first aperture 106 and the second aperture 122 may in their original state misaligned with respect to each other, such that the first aperture 106 and the second aperture 122 may be at an angle with respect to each other, even when no part is accommodated therebetween. In one instance, in this another example, the part 200 may have more thickness than the gap 116 between the first leg 102 and the second leg 104 in the original state. In this example, the part 200 may have a first thickness causing the first leg 102 and the second leg 104 to relatively move with respect to each other to accommodate the part 200. The first thickness may be the minimum thickness from the range of thicknesses of the part 200 that may be fastened through the clip-on u-nut 100. In this another example, the first thickness may relatively move the first leg 102 and the second leg 104 to have the minimum gap therebetween corresponding to the first thickness of the part 200 positionable in the gap 116.

At the minimum gap i.e., the lowest range and extent of gap between the first leg 102 and the second leg 104, at which the first aperture 106 and the second aperture 122 may co-operate with one another may be when the u-bend side of rim 106-1 of the first aperture 106 may substantially align with the first edge 122-1 of the second aperture 122. The minimum gap may be the gap 116 between the first aperture 106 and the second aperture 122 when the first aperture 106 and the second aperture 122 co-operate may be when the u-bend side of rim 106-1 of the first aperture 106 may substantially align with the first edge 122-1 of the second aperture 122. The substantial alignment implies that the central longitudinal axes of the first aperture 106 and the second aperture 122 may not be collinear with one another but may be aligned to a certain extent at an angle with respect to each other, to allow co-operation between the two.

At the maximum gap i.e., highest range and extent of gap 116 between the first leg 102 and the second leg 104, at which the first aperture 106 and the second aperture 122 may be able to co-operate with one another to accommodate the fastener 202. At the maximum gap between the first leg 102 and the second leg 104, the first aperture 106 and the second aperture 122 may co-operate with one another, in a manner that the central longitudinal axes may be positioned at an angle with respect to each other. In an example, the part 200 may be accommodated therebetween. In another example, the part 200 may have a second thickness causing the first leg 102 and the second leg 104 to relatively move with respect to each other to accommodate the part 200. The second thickness in this example may be the maximum thickness from the range of thicknesses of the part 200 that may be fastened through the clip-on u-nut 100. In other words, the second thickness is the maximum thickness of the part 200 that may be accommodated between the first leg 102 and the second leg 104 to be fastened. It may be considered that the part 200 may have any thickness of or between the first thickness and the second thickness to be fastened by the clip-on u-nut 100 of the present subject matter.

At the maximum gap therebetween corresponding to the first thickness of the part 200 positionable in the gap 116, the free end side of rim 106-2 of the first aperture 106 may substantially align with the second edge 122-2 of the second aperture 122. In this example, the maximum gap may be the maximum extent of gap 116 for the first aperture and the second aperture to co-operate. The maximum gap may be when the free end side of rim 106-2 of the first aperture 106 may substantially align with the second edge 122-2 of the second aperture 122. The substantial alignment implies that the central longitudinal axes of the first aperture and the second aperture may not be collinear with one another but may be aligned to a certain extent at an angle with respect to each other, to allow co-operation between the two.

In view of the above, the first leg 102 and the second leg 104 may relatively move with respect to each other to vary the gap 116 to be at or anywhere between the minimum gap and the maximum gap, i.e., when the first aperture 106 of the first leg 102 and the second aperture 122 of the misalignment adjustment component 112 may be in co-operation with one another to be capable of accommodating the fastener 202. As stated above, the first aperture 106 and the second aperture 122 may have the plurality of relative fastening positions with respect to each other, i.e., where the fastener may be accommodated. The plurality of relative fastening position may be any position of the first aperture 106 and the second aperture 122 at and between the minimum gap and the maximum gap between the first leg 102 and the second leg 104 and correspondingly between the first aperture 106 and the second aperture 122 and also being at an angle with respect to each other.

In one example, the first aperture 106 and the second aperture 122 may accommodate the fastener 202 at any one of the plurality of relative fastening positions, where at each of the plurality of relative fastening positions, the first aperture 106 may align with the second aperture 122 at any relative position along the first elongated length of the second aperture 122. Any of the relative position may be the position along the first elongated length at which the first aperture 106 and the second aperture 122 may align. The relative position along the first elongated length at which the fastener may be accommodated may vary based on the gap between the first leg 102 and the second leg 104, that may have bearing on the alignment between the first leg 102 and the second leg 104. The relative position along the first elongated length of the second aperture 122 may imply any position between the first edge 122-1 and the second edge 122-2 at which the first aperture 106 and the second aperture 122 may align with one another at an angle with respect to each other, to receive the fastener 202 depending upon the varying gap between the first leg 102 and the second leg 104 caused by the part 200.

The part 200 may be a panel, a metal sheet, and the like. In an example, for assembling the clip-on u-nut 100 with the part 200. In one example, the part 200 may have an aperture 201 that can align with the apertures (i.e., the first aperture 106 and the second aperture 122) on the clip-on u-nut 100. In an example, the part 200 may have varying thicknesses.

As illustrated in FIG. 2A, the part 200 may be assembled on the locator 110 of the first leg 102, such that the aperture 201 of the part 200 may be located and be accommodated on by the locator 110, as the locator 110 has the same radial dimensions as the first aperture 106. The part 200 may be assembled on the locator 110, such that the aperture 201 of the part 200 may align with the locator 110, as the locator 110 may have the same radial dimensions as the first aperture 106. In this manner, as the part 200 is sandwiched between the first leg 102 and the second leg 104, the part 200 may be accommodated on the locator 110, the locator 110 may hold and lock the part 200 in the fastening position and may not allow the part 200 to move. In this instance, an operator may only have to assemble the part 200 on the locator 110, where the locator 110 may locate the part 200 to accommodate the same, and the locator 110 may restrict the part 200 in the fastening position from any movement and keep the aperture 201 of the part 200 in aligned position with the first aperture 106 of the first leg 102 i.e., at the fastening position, as the fastening operation through the fastener 202 may be in transit.

In one instance, the first aperture 106 and the second aperture 122 may be aligned to a certain extent with one another in the original state, i.e., when the first leg 102 and the second leg 104 are in the home position i.e., when the components stay as is and no external force is applied, and the minimum gap is already between the first leg 102 and the second leg 104 in home position. In one case, the thickness of the part 200 may be less than the gap 116 between the first leg 102 and the second leg 104, the gap 116 between the first leg 102 and the second leg 104 may remain the same as the first leg 102 and the second leg 104 remain in home position. In this instance, the home position of the first leg 102 and the second leg 104 may be the position when the first leg 102 and the second leg 104 stay in respective positions when the part 200 may be accommodated on the locator 110, as no parts are assembled in the clip-on u-nut 100, as illustrated in FIG. 1A. In this instance, no force to cause relative motion between the first leg 102 and the second leg 104 may be applied because the part 200 is of thickness less than the gap 116 and may be easily accommodated therebetween. In this instance, since the minimum gap is already attained in the home position in this example, the fastener 202 may be inserted through the second aperture 122 of the second leg 104 and may correspondingly be caused to pass through the aperture 201 of the part 200, towards the first leg 102 by passing through the first aperture. In another example, the fastener 202 may be inserted through the first aperture 106 of the first leg 102 and may correspondingly be caused to pass through the aperture 201 of the part 200, accommodated between the first leg 102 and the second leg and further towards the second leg 104 by passing through the second aperture 122. In both examples, the fastener 202 may be one of a threaded bolt or a threaded screw. The fastener 202 may be caused to pass through the second aperture of the misalignment adjustment component 112. In this instance, the fastener 202 may easily pass through the misalignment adjustment component 112 and may be adjusted to fasten at any of the respective relative fastening position corresponding to the gap therebetween, by directly engaging with the internal threads of the second aperture 122 and consequently through the first aperture 106 i.e., at the minimum gap. As a result, the part 200 may be fastened to the clip-on u-nut 100, as illustrated in FIG. 2B. The misalignment adjustment component 112 may, through the second aperture 122 having oblong-shaped through-hole provide sufficient space for the fastener to be adjusted to be aligned. As stated above, the diameter of the first aperture 106 corresponds to the width of the second aperture 122, and the size of the aperture corresponds to the size of the fastener, as a result, the width of the second aperture 122 may also correspond to the diameter of the fastener 202. In this regard, in an example, at any of relative fastening positions, the fastener may be accommodated about the width i.e., the second elongated length of the second aperture 122, and the positions of fastening may vary between the first edge 122-1 and the second edge 122-2.

In another instance, the first aperture 106 and the second aperture 122 may be positioned at an angle with respect to each other in the original state and are misaligned with respect to each other, i.e., when the first leg 102 and the second leg 104 are in home position. In one example, the thickness of the part 200 that is to be accommodated in the gap 116 between the first leg 102 and the second leg 104 may be greater than the width of the u-bend 108 between the first leg 102 and the second leg 104 i.e., as the distance between the first leg 102 and the second leg 104 increases. The part 200 when located by the locator 110 and accommodated on the locator 110 may through its thickness, cause the first leg 102 and the second leg 104 to move relatively to accommodate the part 200 with thickness more than the gap 116 that existed when the clip-on u-nut was in original state. For instance, the second leg 104 may be caused to relatively move corresponding to the thickness of the part 200, as illustrated in FIG. 2C. The dotted lines in FIG. 2C depict the relative motion of the second leg 104 and correspondingly cause the misalignment adjustment component 112 to move relatively as well. In this case, as the first aperture 106 and the second aperture 122 were not aligned in original state, the relative motion may cause a change in the gap 116 between the first leg 102 and the second leg 104 to be either the minimum gap or the maximum gap or be between the minimum gap and the maximum gap. This may cause the first aperture 106 and the second aperture 122, that may even though not be aligned or collinear, but to be positioned at an angle from one another and co-operate at any of the plurality of relative fastening positions. The misalignment adjustment component 112 may, through the second aperture 122 having oblong-shaped through-hole provide sufficient space for the fastener to be adjusted to be aligned. As stated above, the diameter of the first aperture 106 corresponds to the width of the second aperture 122, and the size of the aperture corresponds to the size of the fastener, as a result, the width of the second aperture 122 may also correspond to the diameter of the fastener 202. In this regard, in an example, at any of relative fastening positions, the fastener may be accommodated about the width i.e., the second elongated length of the second aperture 122, and the positions of fastening may vary between the first edge 122-1 and the second edge 122-2 depending upon the thickness of the part 200 and the gap 116 between the first leg 102 and the second leg 104.

In another example, the first leg 102 may relatively move and correspondingly cause movement for the first aperture 106 and the second aperture 122 to co-operate at any of the plurality of relative fastening positions at or between the minimum gap and maximum gap to accommodate the fastener 202.

In any of the examples as illustrated above and other examples and variations of clip-on u-nut 100, at any of the variation of the gap 116 caused by the variation of thickness of the part 200, the fastener 202 may be accommodated about the width of the second aperture 122, and the positions of fastening i.e., the relative fastening position may vary to be at or anywhere between the first edge 122-1 and the second edge 122-2 depending upon the thickness of the part 200 and the gap 116 between the first leg 102 and the second leg 104.

With the provision of the misalignment adjustment component 112, the fastener 202, entering through the second aperture 122 of the second leg 104 towards the first leg 102, and vice versa (i.e., from the first aperture 106 to the second aperture 122) to fasten the part 200 accommodated between the first leg 102 and the second leg 104 in the clip-on u-nut 100, may easily enter or be adjusted because of sufficient space provided by the second aperture. This may be possible because of the oblong-shaped through-hole of the second aperture 122 that provides more space to adjust the fastener 202 to fasten the part 200 by easily co-operating with the first aperture 106. In this example, even with the misalignment between the second aperture 122 and first aperture 106, i.e., when the two apertures are not aligned with respect to each other, the oblong-shaped through-hole of the misalignment adjustment component 112 may provide the fastener 202 more space to easily enter and co-operate with the first aperture 106, to engage and lock the part 200. The fastener 202, during misalignment given the oblong-shaped through hole formed at the second aperture 122 and the misalignment adjustment component 112, may easily enter through the second aperture 122 through the body 120 as the area of movement for adjusting and aligning the fastener to further co-operate with the first aperture 106 is more. Consequently, fastening the part 200 through the clip-on u-nut 100 as illustrated in FIG. 2D. In this instance, irrespective of the thickness of the part 200, the clip-on u-nut 100 of the present subject matter may easily and effectively fasten components, such as the part 200.

In an instance, in which misalignment occurs between the first aperture and the second aperture, the plastic fabrication of the clip-on u-nut 100 of the present subject matter aids in adjusting the misalignment and fastening the components. In this instance, as the fastener 202 is inserted through the second aperture 122 towards the first aperture 106 and vice versa i.e., from the first aperture 106 towards the second aperture 122, the oblong shape of the second aperture 122 of the misalignment adjustment component 112 allows the fastener 202 to enter the second aperture. The oblong-shaped through hole of the second aperture 122 provides sufficient space, i.e., to adjust the position of the fastener 202 in the second aperture 122 to effectively fasten at any of the respective relative fastening positions. In order to effectively fasten the part 200, the fastener may be adjusted by the operator about the misalignment adjustment component 112, to cause the fastener 202 to subsequently move through second aperture to the first aperture 106 or vice versa, to effectively fasten the part 200 at any of the relative fastening position. As the clip-on u-nut 100 is fabricated with plastic material, the misalignment adjustment component 112 may also be flexible to adjust to effectively fasten the part 200.

In view of the above arrangement, the clip-on u-nut 100 of the present subject matter may be designed as such to be durable, effective, and less costly. Additionally, the locator of the clip-on u-nut 100 may lock and hold the part 200 during fastening operation and may not require additional force or man-power for fastening the components. Additionally, the clip-on u-nut 100 of the present subject matter is fabricated with plastic material, and therefore the clip-on u-nut may be manufactured through the molding process, which is less time-consuming and less expensive. The clip-on u-nut 100 of the present subject matter through the misalignment adjustment component provides flexibility to the user to fasten components of varying thickness.

FIG. 3 illustrates a fastening assembly 300 comprising the clip-on u-nut 100, according to an example of the present subject matter.

The clip-on u-nut 100 of the present subject matter is designed in a manner to be employed in a fastening assembly 300 to fasten at least two parts/components in an assembly. The fastening assembly 300 may have a first part 304 and a second part 302 that are fastened through the clip-on u-nut, as illustrated in FIG. 3. The clip-on u-nut employed in the fastening assembly 300 corresponds to the clip-on u-nut 1-0 illustrated hereinabove. The clip-on u-nut illustrated in FIG. 3 corresponds to the clip-on u-nut 100 illustrated hereinabove with respect to FIGS. 1-2D. Correspondingly, the first part 304 illustrated in FIG. 3 may correspond to the part 200 illustrated hereinabove with respect to the FIGS. 1-2D. The second part 302 may be, for example, a sheet metal panel, a panel, and the like. The second part 302 may have a second part-hole (not shown) that may correspond to the first aperture 106.

In order to fasten the first part 304 and the second part 302 in the fastening assembly 300, the first part 304 that corresponds to the part 200, may be accommodated between the first leg 102 and the second leg 104. The first leg may have an inner surface and an outer surface, where the inner surface of the first leg 102 may be the surface facing the second leg 104 and the outer surface may be the surface facing away from the second leg 104. The second part 302 may be abutting against the outer surface of the first leg 102.

The first leg 102 and the second leg 104 are relatively moveable with respect to each other about the u-bend 108 to vary the gap 116 therebetween, where the gap 116 is to accommodate the first part 304, as will be explained. In this example, the second aperture 122 is to cooperate with the first aperture to accommodate the fastener 202 to fasten the first part 304 and the second part 302.

In this example, the first leg may have the locator 110 extending from the first leg 102 towards the second leg 104 along an axial direction of the first aperture 106, where the locator 110 may locate any of the first part 304 and the second part 302 with respect to the first leg 102 in a fastening position between the first leg 102 and the second leg 104.

As illustrated in FIG. 3, the outer surface of the first leg 102 may abut against the second part 302, such that a second-part hole 302-1 may correspond to the first aperture 106. The second-part hole 302-1 may be an opening on the second part 302, that may correspond to the size of the fastener, or may also correspond to the size of the locator 110 to allow locating and accommodating the second part 302 on the outer surface of the first leg 102. As stated above, for the sake of clarity with respect to the fastening assembly, the first part 304 may have a first-part hole 304-1, which corresponds to the aperture 201 illustrated with respect to the above examples. The first-part hole 304-1 may receive the fastener 202 and may be aligned with the first aperture 106 to effectively fasten. To accommodate the first part 304, the inner surface of the first leg 102 may accommodate the first part 304, such that a first-part hole 304-1 may correspond to the first aperture 106. The first-part hole 304-1 may be an opening on the first part 304, that may correspond to the size of the fastener 202 or may also correspond to the size of the locator 110 to allow locating and accommodating the first part 304 on the inner surface of the first leg 102.

As illustrated in FIG. 3, while the first aperture 106 and the second-part hole 302-1 may be adjusted to correspond to one another, the fastener 202 may be inserted through the first aperture 106 of the first leg 102 thereby causing it to pass through the second-part hole 302-1 and correspondingly be caused to pass through the aperture 201 of the first part 304, accommodated between the first leg 102 and the second leg and further towards the second leg 104 by passing through the second aperture 122. In one example, the first leg 102 may have the locator 110 on the inner surface as well as on the outer surface, where the locator 110 on the inner surface may be separate from the locator 110 on the outer surface, such that the locator 110 on the inner surface of the first leg 102 may locate and accommodate the first part 304 and the locator 110 on the outer surface of the first leg 102 may locate and accommodate the second part 302. In another example, the first leg 102 may have the locator 110 on the inner surface, such that the locator 110 on the inner surface of the first leg 102 may locate and accommodate the first part 304 and the second part 302 may be held and abut against the outer surface of the first leg, such that the second-part hole 302-1 may correspond to the first aperture 106. In this manner, once the first part 304 and the second part 302 are accommodated on the clip-on u-nut, the fastener may be accommodated at any of the plurality of relative fastening positions, that may depend on the varying gap between the first leg 102 and the second leg 104, caused by the varying thickness of the first part 304 accommodated therebetween.

Similar to the clip-on u-nut 100 illustrated above, the first aperture 106 and the second aperture 122 may have the plurality of relative fastening positions with respect to each other. In each of the plurality of relative fastening positions, the first aperture 106 and the second aperture 122 may accommodate the fastener 202 therein. The first aperture 106 and the second aperture 122 may co-operate with one another to accommodate the fastener 202 to fasten the first part 304 and the second part 302. The second aperture 122 may be capable of accommodating the fastener in co-operation with the first aperture 106. The second aperture 122 and the first aperture 106 may in co-operation with one another, allow the second aperture 122 to receive the fastener 202 to fasten the first part 304 and the second part 302. The fastener 202 when received may through the misalignment adjustment component may be adjusted to fasten the first part 304 and the second part 302 at any of the plurality of relative fastening positions corresponding to the gap between the first leg 102 and the second leg 104.

To summarize the fastening assembly 300 illustrated in FIG. 3, it may have the first part 304, the second part 302 and the clip-on u-nut 100. The clip-on u-nut 100 to fasten the first part 304 to the second part 302 may include the first leg 102 having the first aperture 106, where the first leg 102 may have has an inner surface and an outer surface, the second part abutting the outer surface of the first leg. Further, the clip-on u-nut may have the second leg 104 that may be connected to the first leg 102 through the u-bend 108 to create the gap 116 with the first leg 102. The inner surface of the first leg 102 may face the second leg 104. The first leg 102 and the second leg 104 extending away from the u-bend 108 towards the free end 118 of the clip-on u-nut 100. The second leg 104 having the misalignment adjustment component 112 may have the body 120 and the second aperture 122. The second aperture 122 may be formed as the oblong-shaped through-hole in the body 120 of the misalignment adjustment component 112 to receive the fastener 202. The second aperture 122 may cooperate with the first aperture to accommodate the fastener 202 to fasten the first part 304 and the second part 302. The first leg 102 and the second leg 104 may be relatively moveable with respect to each other about the u-bend 108 to vary the gap 116 therebetween, where the gap 116 is to accommodate the first part 304. Further, the first aperture 106 and the second aperture 122, depending on the gap 116 between the first leg 102 and the second leg 104, may have a plurality of relative fastening positions with respect to each other. Further, in each of the plurality of relative fastening positions the first aperture 106 and the second aperture 122 are to accommodate the fastener 202 therein.

As stated above, the clip-on u-nut of the fastening assembly 300 illustrated with respect to FIG. 3 may correspond to and may work similarly as the clip-on u-nut 100 illustrated above, and the working and the features and constructions are repeated herein for the sake of brevity.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A clip-on u-nut (100) comprising:
a first leg (102) having a first aperture (106); and
a second leg (104) connected to the first leg (102) through a u-bend (108) to create a gap (116) with the first leg (102), wherein the first leg (102) and the second leg (104) extend away from the u-bend (108) towards a free end (118) of the clip-on u-nut (100), the second leg (104) comprising a misalignment adjustment component (112) having:
a body (120), and
a second aperture (122), wherein the second aperture (122) is formed as an oblong-shaped through-hole in the body (120) of the misalignment adjustment component (112), and the second aperture (122) is capable of accommodating a fastener (202) in co-operation with the first aperture (106),
wherein the first leg (102) and the second leg (104) are relatively moveable with respect to each other about the u-bend (108) to vary the gap (116) therebetween, wherein the gap (116) is to accommodate a part (200), the first aperture (106) and the second aperture (122), depending on the gap (116) between the first leg (102) and the second leg (104), having a plurality of relative fastening positions with respect to each other, and, in each of the plurality of relative fastening positions, the first aperture (106) and the second aperture (122) are to accommodate the fastener (202) therein.

2. The clip-on u-nut (100) of claim 1, wherein the first aperture (106) comprises a u-bend side of rim (106-1) and a free end side of rim (106-2), the u-bend side of rim (106-1) being in proximity to the u-bend (108) and the free end side of rim (106-2) being in proximity to the free end (118), and
the second aperture (122) comprises a first edge (122-1) and a second edge (122-2), the first edge (122-1) being in proximity to the u-bend (108) and the second edge (122-2) being in proximity to the free end (118),
wherein at a minimum gap between the first leg (102) and the second leg (104), corresponding to a first thickness of the part (200) positionable in the gap (116), the u-bend side of rim (106-1) of the first aperture (106) is to substantially align with the first edge (122-1) of the second aperture (122), and at a maximum gap between the first leg (102) and the second leg (104), corresponding to a second thickness of the part (200) positionable in the gap (116), the free end side of rim (106-2) of the first aperture (106) is to substantially align with the second edge (122-2) of the second aperture (122).

3. The clip-on u-nut (100) of claim 2, wherein for the gap (116) being between the minimum gap and the maximum gap, the first aperture (106) and the second aperture (122) have the plurality of relative fastening positions with respect to each other to accommodate the fastener (202) in co-operation with each other.

4. The clip-on u-nut (100) of claim 2, wherein the second aperture (122) formed as the oblong-shaped through-hole has a first elongated length and a second elongated length, wherein the first elongated length is a length, measured along a longitudinal axis of the second aperture (122) in direction of an oblong shape, between the first edge (122-1) and the second edge (122-2), and the second elongated length is measured perpendicular to a direction of measurement of the first elongated length and is a measure of a width of the second aperture (122), wherein the width of the second elongated length of second aperture (122) of the misalignment adjustment component (112) is substantially equal to a diameter of the first aperture (106) and the first elongated length is substantially greater than the width of the second aperture and the diameter of the first aperture (106).

5. The clip-on u-nut (100) of claim 4, wherein the first aperture (106) and the second aperture (122) are to accommodate the fastener (202) at any one of the plurality of relative fastening positions, wherein at each of the plurality of relative fastening positions, the first aperture (106) is to align with the second aperture (122) along the first elongated length of the second aperture (122).

6. The clip-on u-nut (100) of claim 1, wherein the first leg (102) comprises a locator (110) extending from the first leg (102) towards the second leg (104) along an axial direction of the first aperture (106), the locator (110) being to locate the part (200) with respect to the first leg (102) in a fastening position between the first leg (102) and the second leg (104).

7. The clip-on u-nut (100) of claim 1, wherein the first aperture (106) and the second aperture (122) comprise a plurality of internal threads.

8. The clip-on u-nut (100) of claim 1, wherein the clip-on u-nut (100) is fabricated with a plastic material and is manufactured by a molding process.

9. A fastening assembly (300) comprising:
a first part (304);
a second part (302); and
a clip-on u-nut (100) to fasten the first part (304) to the second part (302), wherein the clip-on u-nut (100) comprises:
a first leg (102) having a first aperture (106), wherein the first leg (102) has an inner surface and an outer surface, the second part abutting the outer surface of the first leg; and
a second leg (104) connected to the first leg (102) through a u-bend (108) to create a gap (116) with the first leg (102), wherein the inner surface of the first leg (102) faces the second leg (104), the first leg (102) and the second leg (104) extending away from the u-bend (108) towards a free end (118) of the clip-on u-nut (100) and, the second leg (104) comprising a misalignment adjustment component (112) having:
a body (120), and
a second aperture (122), wherein the second aperture (122) is formed as an oblong-shaped through-hole in the body (120) of the misalignment adjustment component (112); and
a fastener, wherein the second aperture (122) is to cooperate with the first aperture to accommodate the fastener (202) to fasten the first part (304) and the second part (302),
wherein the first leg (102) and the second leg (104) are relatively moveable with respect to each other about the u-bend (108) to vary the gap (116) therebetween, wherein the gap (116) is to accommodate the first part (304),
the first aperture (106) and the second aperture (122), depending on the gap (116) between the first leg (102) and the second leg (104), having a plurality of relative fastening positions with respect to each other, and in each of the plurality of relative fastening positions the first aperture (106) and the second aperture (122) are to accommodate the fastener (202) therein.

10. The fastening assembly (300) of claim 9, wherein the first aperture (106) comprises a u-bend side of rim (106-1) and a free end side of rim (106-2), the u-bend side of rim (106-1) being in proximity to the u-bend (108) and the free end side of rim (106-2) being in proximity to the free end (118), and
the second aperture (122) comprises a first edge (122-1) and a second edge (122-2), the first edge (122-1) being in proximity to the u-bend (108) and the second edge (122-2) being in proximity to the free end (118)
wherein at a minimum gap between the first leg (102) and the second leg (104), corresponding to a first thickness of the first part (304) positionable in the gap (116), the u-bend side of rim (106-1) of the first aperture (106) is to substantially align with the first edge (122-1) of the second aperture (122), and at a maximum gap between the first leg (102) and the second leg (104), corresponding to a second thickness of the first part (304) positionable in the gap (116), the free end side of rim (106-2) of the first aperture (106) is to substantially align with the second edge (122-2) of the second aperture (122).

11. The fastening assembly (300) of claim 10, wherein for the gap (116) being between the minimum gap and the maximum gap, the first aperture (106) and the second aperture (122) have the plurality of relative fastening positions with respect to each other to accommodate the fastener (202) in co-operation with each other.

12. The fastening assembly (300) of claim 10, wherein the second aperture (122) formed as the oblong-shaped through-hole has a first elongated length and a second elongated length, wherein the first elongated length is a length, measured along a longitudinal axis of the second aperture (122) in direction of an oblong shape, between the first edge (122-1) and the second edge (122-2), and the second elongated length is measured perpendicular to a direction of measurement of the first elongated length as is a measure of a width of the second aperture (122), wherein the width of the second elongated length of second aperture (122) of the misalignment adjustment component (112) is substantially equal to a diameter of the first aperture (106) and the first elongated length is substantially greater than the width of the second aperture and the diameter of the first aperture (106).

13. The fastening assembly (300) of claim 12, wherein the first aperture (106) and the second aperture (122) are to accommodate the fastener (202) at any one of the plurality of relative fastening positions, wherein at each of the plurality of relative fastening positions, the first aperture (106) is to align with the second aperture (122) along the first elongated length of the second aperture (122).

14. The fastening assembly (300) of claim 9, wherein the first leg (102) comprises a locator (110) extending from the first leg (102) towards the second leg (104) along an axial direction of the first aperture (106),
the locator (110) being to locate any of the first part (304) and the second part (302) with respect to the first leg (102) in a fastening position between the first leg (102) and the second leg (104).

15. The fastening assembly (300) of claim 9, wherein the first aperture (106) and the second aperture (122) comprise a plurality of internal threads.

16. The fastening assembly (300) of claim 9, wherein the clip-on u-nut (100) is fabricated with plastic material and is manufactured by a molding process.

17. The fastening assembly (300) of claim 9, wherein the second part (302) comprises a second-part hole (302-1) to receive the fastener (202), the second-part hole (302-1) is aligned with at least the first aperture (106).

18. The fastening assembly (300) of claim 9, wherein the first part (304) comprises a first-part hole (304-1) to receive the fastener (202), the first-part hole (304-1) is aligned with at least the first aperture (106).
